(19) United States
(12) Patent Application Publication
(10) Pub. No.: US 2008/0274435 A1
(43) Pub. Date: Nov. 6, 2008

(54) Crimping Pliers, Especially for Orthodontic Applications

(76) Inventor: Arthur L. Wool, Wyomissing, PA (US)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/114,924

(22) Filed: May 5, 2008

Related U.S. Application Data
(60) Provisional application No. 60/924,207, filed on May 3, 2007.

(51) Int. Cl. A61C 3/00

(52) U.S. Cl. 433/4

(57) ABSTRACT

Orthodontic crimping pliers include a first member having a first handle at a first end and a first jaw at a second end, the first jaw having a first flat edge, a second member having a second handle at a first end and a second jaw at a second end having a second flat edge and a pivot connecting the first and second members and allowing the first and second members to pivot with respect to one another so that pivoting the first handle towards the second handle causes the first jaw and the second jaw to move from an open position with the first and second jaws spaced apart toward a closed position with the first flat edge of the first jaw and second flat edge of the second jaw adjacent one another. In the closed position, the first flat edge of the first jaw and second flat edge of the second jaw are parallel and adjacent one another over a width of 0.005 to 0.015 inches.

### CROSS-REFERENCE TO RELATED APPLICATION

This application is a Nonprovisional Application and claims benefit of the filing date of provisional application Ser. No. 60/924,207, filed May 3, 2007, the contents of which are incorporated herein by reference.

### BACKGROUND OF THE INVENTION

It is known to provide crimpable tubes on arch wires to function as, e.g., stops and to provide crimpable posts and/or hooks. Cutting pliers and crimping pliers are also known. However, there is a need to provide an improved plier that can be used to easily crimp a tube, post or hook onto an archwire. The present invention relates to a crimping plier that can be used to easily crimp a tube, post or hook onto an archwire, but is not limited to such a use.

### SUMMARY OF THE INVENTION

The present invention relates to orthodontic crimping pliers including a first member having a first handle at a first end and a first jaw at a second end, the first jaw having a first flat edge, a second member having a second handle at a first end and a second jaw at a second end having a second flat edge and a pivot connecting the first and second members and allowing the first and second members to pivot with respect to one another so that pivoting the first handle towards the second handle causes the first jaw and the second jaw to move from an open position with the first and second jaws spaced apart toward a closed position with the first flat edge of the first jaw and second flat edge of the second jaw adjacent one another. In the closed position, the first flat edge of the first jaw and second flat edge of the second jaw are parallel and adjacent one another over a width of 0.005 to 0.015 inches.

### BRIEF DESCRIPTION OF THE DRAWINGS

FIGS. 1A and 1B are perspective views of opposite sides of crimping pliers according to the present invention;

FIG. 2 is a side view of the pliers;

FIG. 3 is a plan view of the jaws of the pliers;

FIG. 4 is an enlarged schematic plan view of the jaws of the pliers.

### DESCRIPTION OF THE INVENTION

An excellent crimping pliers may be constructed by modifying the ETM (Ormco) pliers #1010 (end cutter/non holding) by constructing the pliers to have blunt (flat) parallel, opposing edges instead of the normal sharp edges. The flat surfaces would be in the range of, e.g., 0.005 to 0.015 inches in width. With this design, a single hard squeeze (crimp) near or at the midpoint of the stop, hook or post or, preferably, two crimps, one at each at the ends of the stop, hook or post, will produce a very tight hold between the crimp stop, hook or post and the underlying wire.

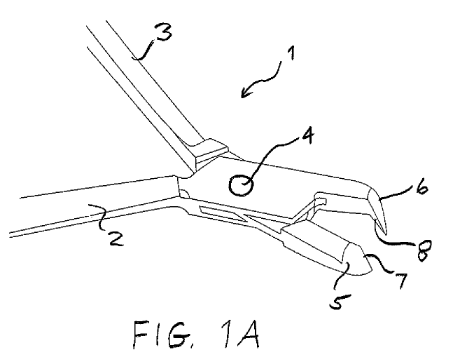

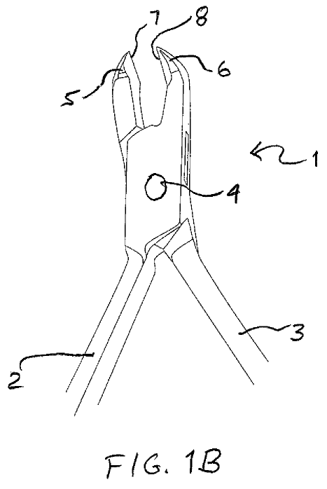

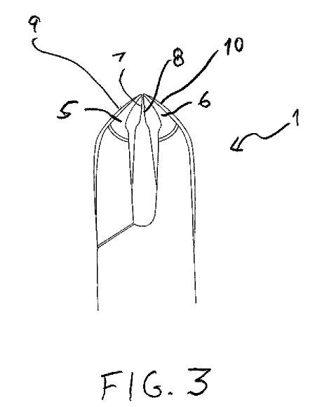

FIGS. 1-4 show an embodiment of the present invention. As shown therein, the pliers 1 have first and second members, each having a handle at one end and a jaw at another end. Thus, handles 2, 3 are interconnected at pivot 4 and jaws 5, 6 as known in the art. The edges 7, 8, however are not sharp edges, but are blunt, i.e., flat or substantially flat parallel, opposing edges (i.e., that do not constitute a cutting edge).

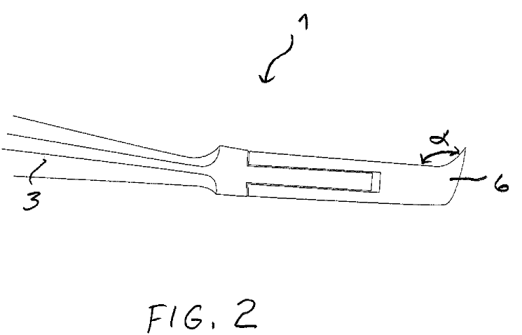

The edges 7, 8 can protrude from and be formed at an angle to the jaws 5, 6 if desired, as shown more clearly in FIG. 2. The angle a can be in the range of 50-80°.

The jaws 5, 6 can be tapered as shown, if desired, at edges 9, 10 to make it easier to reach portions of a patient's mouth. Also, the foremost ends of the jaws 5, 6 can be flat and the opposite side forming the edges 7, 8 can be tapered to make it easier to reach portions of a patient's mouth.

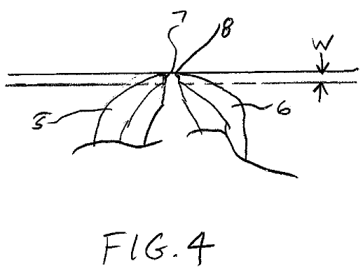

As shown in FIG. 4, the parallel, opposing flat edges 7, 8 can have a width w of, e.g., in the range of 0.005 to 0.015 inches.

Pivoting of the first handles 2, 3 towards one another causes the jaws 5, 6 to move from an open position with the jaws 5, 6 spaced apart toward a closed position with the first flat edge 7 of the first jaw 5 and second flat edge 8 of the second jaw 6 adjacent one another. In the closed position, the first flat edge 7 of the first jaw 5 and second flat edge 8 of the second jaw 6 are parallel and adjacent one another over t width w of 0.005 to 0.015 inches. By “adjacent,” applicant means both touching and slightly apart (apart by less than the thickness of an archwire).

With this design, a single hard squeeze (crimp) near or at the midpoint of the stop, hook or post or, preferably, two crimps, one at each at the ends of the stop, hook or post, will produce a very tight hold between the crimp stop, hook or post and the underlying wire.

While the pliers have been described especially for use in crimping tubes, posts and hooks on orthodontic archwires, the pliers may be used to crimp other items, and other modifications may be made to the pliers as would be understood by those skilled in the art.

I claim:

1. Orthodontic crimping pliers comprising:
a first member having a first handle at a first end and a first jaw at a second end, the first jaw having a first flat edge;
a second member having a second handle at a first end and a second jaw at a second end having a second flat edge;
a pivot connecting the first and second members and allowing the first and second members to pivot with respect to one another so that pivoting the first handle towards the second handle causes the first jaw and the second jaw to move from an open position with the first and second jaws spaced apart toward a closed position with the first flat edge of the first jaw and second flat edge of the second jaw adjacent one another;
wherein, in the closed position, the first flat edge of the first jaw and second flat edge of the second jaw are parallel and adjacent one another over a width of 0.005 to 0.015 inches.
